(19) United States
(12) Patent Application Publication
(10) Pub. No.: US 2015/0344273 A1
(43) Pub. Date: Dec. 3, 2015

(54) CRANE WITH HEAVE COMPENSATION

(71) Applicant: INNOVATIVE INPUT B.V., GS Ridderkerk (NL)

(72) Inventor: Pieter KALKMAN, Waddinxveen (NL)

(21) Appl. No.: 14/759,550

(22) PCT Filed: Jan. 7, 2014
(86) PCT No.: PCT/NL2014/050002

§ 371 Date: Jul. 7, 2015

(30) Foreign Application Priority Data
Jan. 8, 2013 (NL) 2010094

(51) Int. Cl. B66C 23/16; B66C 23/52; B66C 13/04; B63B 27/10; B66C 23/68

(52) U.S. Cl. CPC B66C 23/166; B63B 27/10; B66C 23/68; B66C 13/04; B66C 23/52

(57) ABSTRACT

A crane includes a base (1, 2), an articulated jib (3, 4) which is supported by the base, as well as hoisting elements (5, 9) which are guided from the base via the jib, such as a hoisting cable. The jib includes jib parts (3, 4) which are rotatably supported with respect to each other and with respect to the base (1, 2), as well as respective jib part drives (10-12) for varying the angular position of jib parts with respect to the base or with respect to another jib part. One of the jib part drives has series-connected linear actuators (11, 12), one of which is connected to one of the jib parts and the other of which is connected to a jib part adjoining the jib part and which linear drives cooperate with each other via a guide (13) on the jib.

The invention relates to a crane, comprising a base, an articulated jib which is supported by the base, as well as hoisting means which are guided from the base via the jib, such as a hoisting cable, which articulated jib comprises jib parts which are rotatably supported with respect to each other and with respect to the base, as well as respective jib part drives for varying the angular position of jib parts with respect to the base or with respect to another jib part.

Such a crane is known from WO-A-2009/036456. This crane has a jib which consists of two jib parts which are connected to each other by means of parallel, horizontally directed hinges. These jib parts can be moved into the desired position and fixed by means of hydraulic piston/cylinder devices. The jib is fitted to a base and can be pivoted to and fro via a slew ring with vertical axis of rotation.

The crane is situated on board a ship and can be used for carrying out operations on water, such as at sea or on a river and the like. Depending on the prevailing weather conditions, the ship, and thus the crane, is subjected to heaving movements which result in up and down movements of the jib of the crane, and thus of the hoisting cable. This affects the operations for which the crane is being used. If, for example, a load has to be transferred between two ships, or work has to be carried out on the bottom of the water, the heave may lead to collisions. The load is then subjected to relatively significant decelerations/accelerations which may lead to damage.

With this known crane, an attempt has been made to provide a degree of compensation for these heaving movements via the control unit of the winch onto which the hoisting cable is wound. The control unit is coupled to a measuring system which detects the heaving movements. Depending on the detected heaving movements of the ship, the hoisting cable is wound off or wound up, in such a way that the load on the hoisting cable is protected against these heaving movements. A drawback of this known method of heave compensation is that the control unit of the winch is complicated, and is accompanied by a degree of slowness which results in the fact that the heaving movements cannot be entirely cancelled out.

It is therefore an object of the invention to provide a crane which is better able to compensate for the heaving movements. This object is achieved by the fact that one of the jib part drives comprises series-connected linear actuators, one of which is connected to one of the jib parts and the other of which is connected to a jib part adjoining said jib part and which linear drives cooperate with each other via a guide on the jib.

With the crane according to the invention, the jib parts can be rotated with respect to each other and be brought into the desired position and fixed by the linear actuators, preferably hydraulic piston/cylinder devices. However, in addition, one of the actuators of the two series-connected actuators can be used to displace the respective jib part around the position fixed by the other actuators. By means of this actuator, it is thus possible to generate adjusting movements of the jib, and thus of the hoisting cable. It is therefore not necessary to influence the winch for this purpose; the latter can be operated in the normal way for lifting or lowering the load. In particular, one of the actuators of the series-connected actuators can be operated as a heave compensator. This actuator which acts as a heave compensator is operated by the control system based on the detected heaving movements.

The guide may be configured in different ways, for example as a guide which is displaceable with respect to one of the jib parts in accordance with a predetermined path. This may involve linear or rectilinear movements, rotating movements or a combination thereof. Preference is given to a guide which comprises a tilting member which is rotatably suspended from at least one of the jib parts which are connected to the series-connected actuators.

In this case, various positions are conceivable. According to a first possibility, the tilting member may be suspended between and at a distance from both ends or both pivoting connections of one of the jib parts which are connected to the series-connected actuators. In this variant, it is possible to ensure that the tilting member, the jib parts which are connected to the series-connected actuators and the actuator which is situated between the other jib part and tilting member, which actuator is set to a length which is equal to the distance between the pivoting connection of said one jib part and the tilting member on the one hand, and the pivoting connection between both jib parts on the other hand, cooperate according to pivoting connections which are situated on the four respective corners of a parallelogram. The actuator which is set to such a length that the parallelogram shape is obtained is then fixed, while the other actuator of the series-connected actuators acts as a heave compensator.

The advantage of this embodiment is that this heave compensator is situated at a position which is relatively close to the base. As a result thereof, the connections, in particular hydraulic lines, can remain short. The jib parts situated further towards the end are not fitted with such components, thus reducing the susceptibility of the crane to failure. Due to the parallelogram shape, the lengthening/shortening of the heave compensator is copied exactly by the jib part which is situated further outwards, thus facilitating the desired heave control of the crane.

According to another possibility, the suspension of the tilting member may coincide with the pivoting connection between the jib parts which are connected to the series-connected actuators. The linear drive between the tilting member and the jib part which is situated further outwards, such as the farthest jib part, that is to say the jib part which forms the free end of the jib, then preferably acts as an active heave compensator. This embodiment has the advantage that the jib can be placed in various positions, reaching outwards to a greater or lesser extent, whereas it is still possible to achieve heave compensation at all times by means of the actuator which acts as a heave compensator.

Preferably, two and only two jib parts are provided, such as a top jib part which is directly connected to a base jib part which is directly supported by the base. However, it is also possible to use more than two series-connected jib parts which are all rotatably connected to each other in pairs.

The invention also relates to methods for operating the different variants of the crane which have been described above. This method comprises the following steps:
blocking one of the series-connected actuators,
making a jib part which is connected to the blocked actuator of the series-connected actuators pivot to and fro while shortening or lengthening, respectively, the other actuator of the series-connected actuators, preferably about a horizontal position of that jib part.

With a crane having only two jib parts, the method comprises the following steps:
placing the top jib part in an approximately horizontal position,
blocking the actuator between the tilting member and the top jib part,
making the top jib part pivot to and fro about the horizontal position while shortening or lengthening, respectively, the other actuator of the series-connected actuators.

According to another possibility, the method may comprise the following steps:
placing the top jib part in an approximately horizontal position,
blocking the actuator between the tilting member and the base jib part,
making the top jib part pivot to and fro about the horizontal position while shortening or lengthening, respectively, the other actuator of the series-connected actuators.

Finally, the invention relates to a vessel or platform provided with a crane as described above.

The invention will be described below with reference to the exemplary embodiments illustrated in the figures, in which:

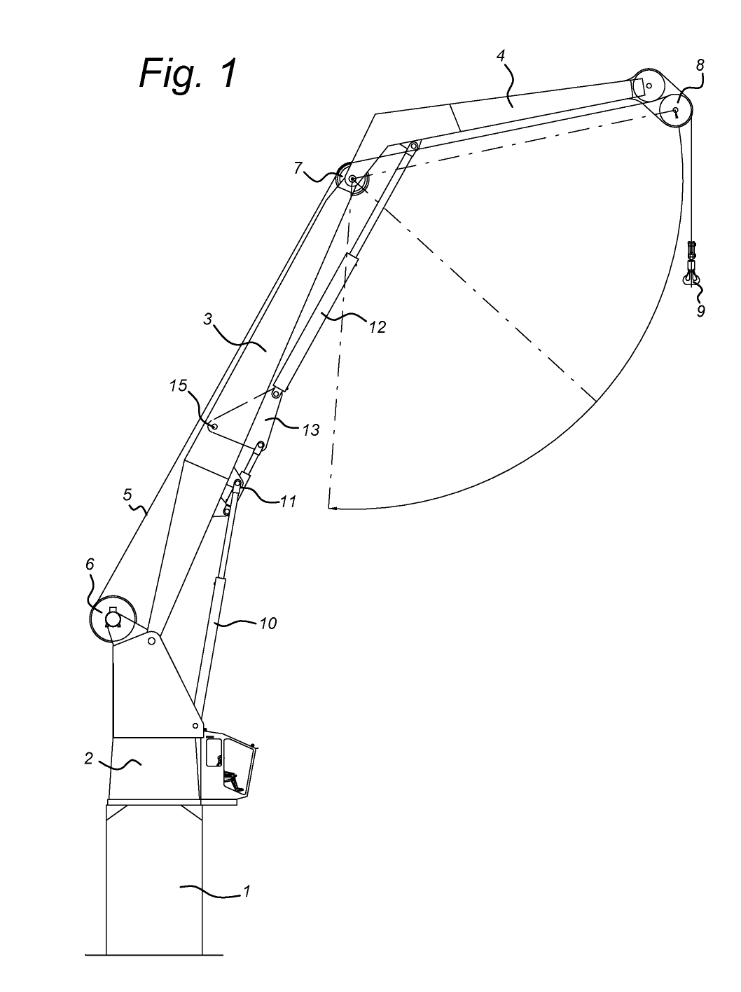

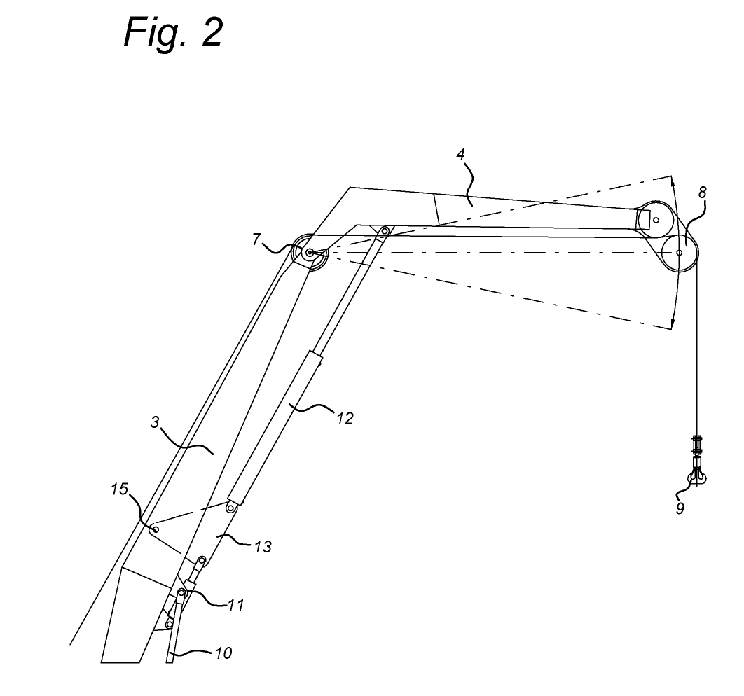

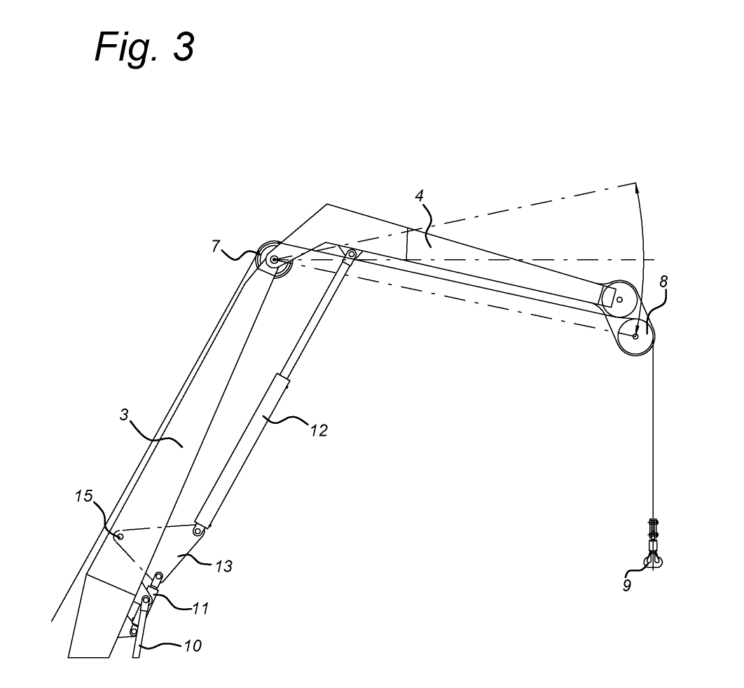

FIGS. 1-4 show a first variant of the crane;

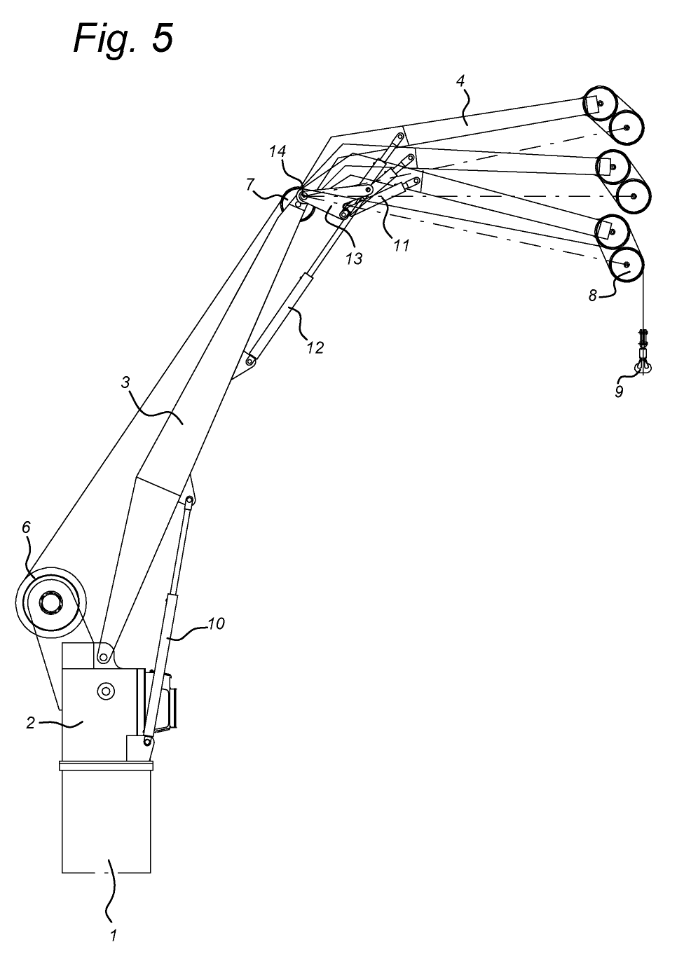

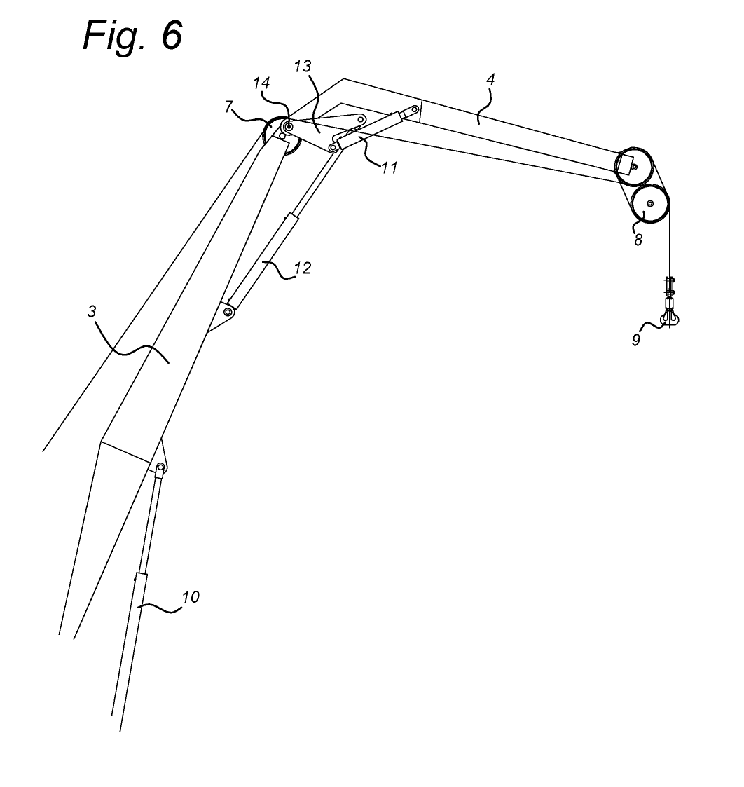

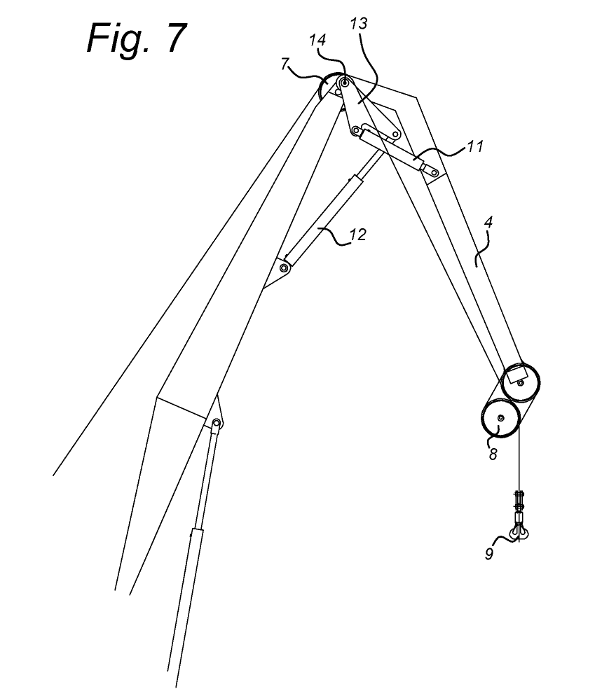

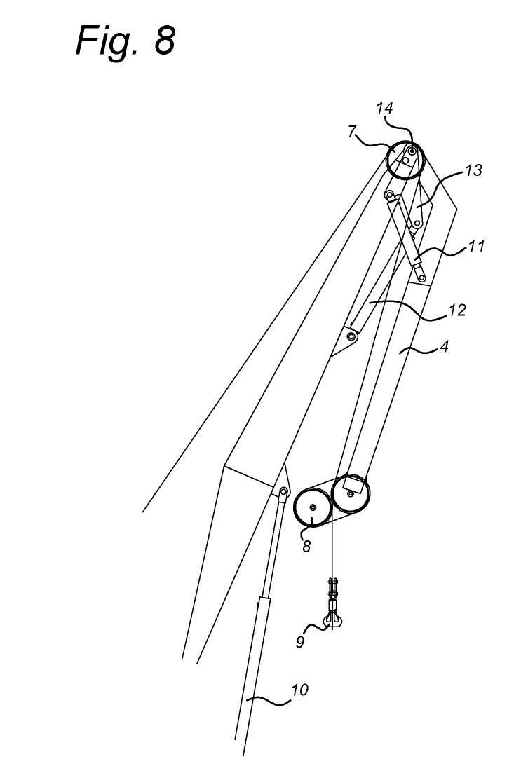

FIGS. 5-8 show a second variant.

The crane illustrated in FIGS. 1-4 is placed on a foot 1 which may be mounted on a ship or platform. The base or the crane housing 2 of the crane is fitted on this foot so as to be rotatable about a vertical axis. A cab with operating controls is incorporated in this crane housing in a known manner. The drive for the various installations of the crane may also be provided in this crane housing. The base jib part 3 is fitted on the crane housing 2 so as to be rotatable about a substantially horizontal axis; the top jib part 4 is likewise fitted to the base jib part so as to be rotatable about an axis which runs parallel thereto. From the winch 6 on the crane housing, the hoisting cable 5 is guided along these jib parts 3,4 via suitable discs 7 and 8; at the end of the hoisting cable 5, the hook 9 is provided.

The base jib part 3 can be controlled with respect to the crane housing on account of the piston/cylinder device 10 which is rotatably connected to said crane housing on one side and to the base jib part on the other side. The top jib part can be controlled by two series-connected piston/cylinder devices 11, 12. At their mutually facing ends, these series-connected piston/cylinder devices 11, 12 are to this end connected to the tilting member 13 which is in turn rotatably connected to the base jib part 3 via the pivoting suspension 15. At their other end, the series-connected piston/cylinder devices 11, 12 are connected to the base jib part 3 and the top jib part 4, respectively.

By means of the piston/cylinder device 10 and the piston/cylinder device 12 connected to the top jib part, the jib parts can be placed in a certain desired position with respect to each other. By varying the length of the series-connected piston/cylinder device 11 connected to the base jib part, the top jib part can then be pivoted up and down in order to compensate for the heaving movements via the other series-connected but fixed piston/cylinder device 11. In this case, the length of the series-connected piston/cylinder device 12 connected to the top jib part is preferably set in such a manner that a parallelogram shape is defined by the mutual connections of the base jib part 3, the top jib part 4, the tilting member 13 and said piston/cylinder device 12.

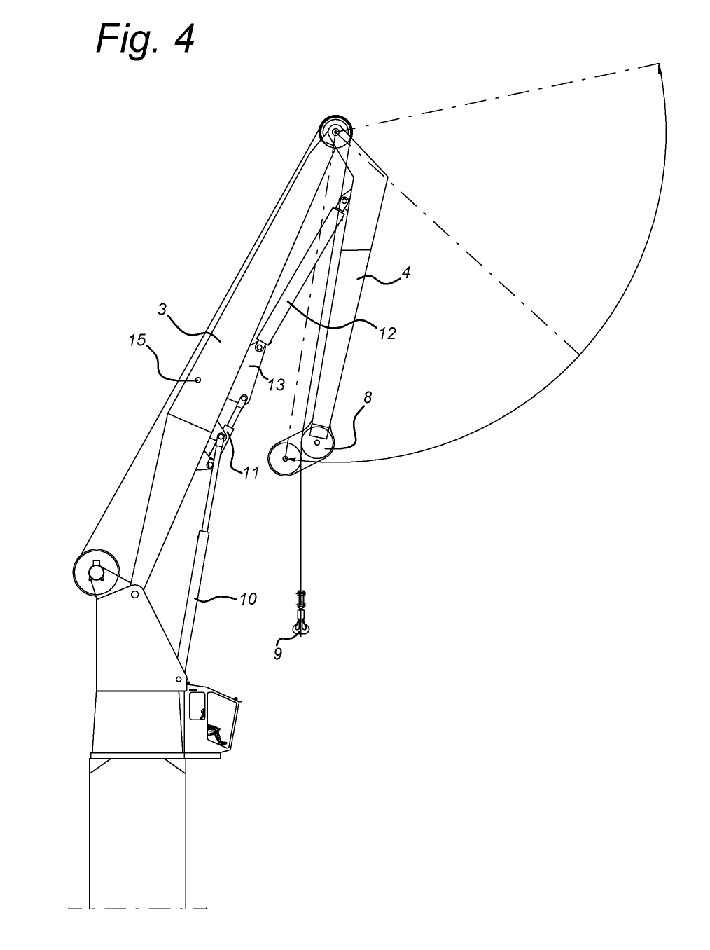

In FIGS. 1-3, the top jib part 4 is placed in a substantially horizontal, nominal position. The top jib part can be pivoted up and down about this position by the piston/cylinder device 11 acting as a heave compensator. In this case, an optimum compensation movement for the hoisting cable 5 with hook 9 is achieved which takes place in a substantially vertical direction and hardly has a horizontal component. However, the crane may also be moved outside this compensation area, as is illustrated in FIG. 4, in which the hook is moved as closely to the foot 1 as possible.

In the variant from FIGS. 5-8, various components which are identical to those of FIGS. 1-4 are denoted by the same reference numerals. In this case, the tilting member 13 is rotatably connected to the pivoting connection 14 between the base jib part 3 and the top jib part 4. The hydraulic piston/cylinder device 10 is fitted between the crane housing 2 and the base jib part 3, the hydraulic piston/cylinder device 12 between the base jib part 3 and the tilting member 13. Furthermore, the hydraulic piston/cylinder device 11 is fitted between the tilting member 13 and the top jib part 4.

After the hydraulic piston/cylinder devices 10, 12 have been put in a fixed position, the position of the top jib part can be varied about the substantially horizontal starting position in order to compensate for heaving movements by varying the length of the hydraulic piston/cylinder device 11 which acts as a heave compensator.

### List of Reference Numerals

1. Foot
2. Crane housing
3. Base jib part
4. Top jib part
5. Cable
6.-8. Disc
9. Hook
10.-12. Piston/cylinder device
13. Tilting member
14. Pivoting connection between jib parts
15. Pivoting suspension

1. Crane, comprising a base (1, 2), an articulated jib (3, 4) which is supported by the base, as well as hoisting means (5, 9) which are guided from the base via the jib, such as a hoisting cable, which articulated jib comprises jib parts (3, 4) which are rotatably supported with respect to each other and with respect to the base (1, 2), as well as respective jib part drives (10-12) for varying the angular position of jib parts with respect to the base or with respect to another jib part, wherein one of the jib part drives comprises series-connected linear actuators (11, 12), one of which is connected to one of the jib parts and the other of which is connected to a jib part adjoining said jib part and which linear drives cooperate with each other via a guide (13) on the jib.

2. Crane according to claim 1, wherein one of the actuators (11, 12) of the series-connected actuators can be operated as a heave compensator.

3. Crane according to claim 1, wherein the guide (13) is suspended from at least one of the jib parts which are connected to the series-connected actuators.

4. Crane according to claim 3, wherein the guide comprises a tilting member (13) which is rotatably (15) suspended from at least one of the jib parts which are connected to the series-connected actuators.

5. Crane according to claim 3, wherein the guide (13) is suspended between and at a distance from both ends or both pivoting connections of one of the jib parts (3) which are connected to the series-connected actuators.

6. Crane according to claim 5, wherein the tilting member (13), the jib parts (3, 4) which are connected to the series-connected actuators and the actuator (12) which is situated between the other jib part (4) and tilting member (13), which actuator (12) is set to a length which is equal to the distance between the pivoting connection of said one jib part and the tilting member on the one hand, and the pivoting connection between both jib parts on the other hand, cooperate according to pivoting connections which are situated on the four respective corners of a parallelogram.

7. Crane according to claim 6, wherein one of the actuators of the series-connected actuators can be operated as a heave compensator, and the other actuator (11) of the series-connected actuators acts as a heave compensator.

8. Crane according to claim 4, wherein the suspension of the tilting member (13) coincides with the pivoting connection (14) between the jib parts (3, 4) which are connected to the series-connected actuators (11, 12).

9. Crane according to claim 8, wherein one of the actuators of the series-connected actuators can be operated as a heave compensator, and the linear drive (11) between the tilting member (13) and the farthest jib part (4) acts as an active heave compensator.

10. Crane according to claim 5, wherein two and only two jib parts (3, 4) are provided, such as a top jib part (4) which is directly connected to a base jib part (3) which is directly supported by the base (1, 2).

11. Method for operating the crane according to claim 1, comprising the following steps:
blocking one (12) of the series-connected actuators (11, 12),
making a jib part (4) pivot to and fro while shortening or lengthening, respectively, the other actuator (11) of the series-connected actuators, preferably about a horizontal position of that jib part (4).

12. Method for operating the crane according to claim 10, comprising the following steps:
placing the top jib part (4) in an approximately horizontal position,
blocking the actuator (12) between the tilting member (13) and the top jib part (4),
making the top jib part (4) pivot to and fro about the horizontal position while shortening or lengthening, respectively, the other actuator (11) of the series-connected actuators.

13. Method for operating the crane according to claim 8 wherein the suspension of the tilting member (13) coincides with the pivoting connection (14) between the jib parts (3, 4) which are connected to the series-connected actuators, comprising the following steps:
placing the top jib part (4) in an approximately horizontal position,
blocking the actuator (12) between the tilting member (13) and the base jib part (3),
making the top jib part (4) pivot to and fro about the horizontal position while shortening or lengthening, respectively, the other actuator (11) of the series-connected actuators (11, 12).

14. Vessel comprising a floating hull and a crane according to claim 1 mounted on the hull, comprising a base, an articulated jib which is supported by the base, as well as hoisting means which are guided from the base via the jib, such as a hoisting cable, which articulated jib comprises jib parts which are rotatably supported with respect to each other and with respect to the base, as well as respective jib part drives for varying the angular position of jib parts with respect to the base or with respect to another jib part, wherein one of the jib part drives comprises series-connected linear actuators, one of which is connected to one of the jib parts and the other of which is connected to a jib part adjoining said jib part and which linear drives cooperate with each other via a guide on the jib.

15. Platform comprising a deck and legs which extend downwards from the deck, as well as a crane according to claim 1 mounted on the deck, comprising a base, an articulated jib which is supported by the base, as well as hoisting means which are guided from the base via the jib, such as a hoisting cable, which articulated jib comprises jib parts which are rotatably supported with respect to each other and with respect to the base, as well as respective jib part drives for varying the angular position of jib parts with respect to the base or with respect to another jib part, wherein one of the jib part drives comprises series-connected linear actuators, one of which is connected to one of the jib parts and the other of which is connected to a jib part adjoining said jib part and which linear drives cooperate with each other via a guide on the jib.

16. Crane according to claim 2, wherein the guide (13) is suspended from at least one of the jib parts which are connected to the series-connected actuators.

17. Crane according to claim 4, wherein the guide (13) is suspended between and at a distance from both ends or both pivoting connections of one of the jib parts (3) which are connected to the series-connected actuators.

18. Crane according to claim 1, wherein two and only two jib parts (3, 4) are provided, such as a top jib part (4) which is directly connected to a base jib part (3) which is directly supported by the base (1, 2).
